(19) United States
(12) Patent Application Publication
(10) Pub. No.: US 2003/0201350 A1
(43) Pub. Date: Oct. 30, 2003

(54) V-Drum cutting head

(76) Inventor: Keith William Garl, Goleta, CA (US)

Correspondence Address: Keith William Garl, 747 South Kellogg Avenue, Goleta, CA, 93117, US

(21) Appl. No.: 10/307,626

(22) Filed: Dec. 2, 2002

Related U.S. Application Data
(60) Provisional application No. 60/375,759, filed on Apr. 26, 2002.

(51) Int. Cl. B02C 18/22

(52) U.S. Cl. 241/55; 241/93

(57) ABSTRACT

An improved cutting heads for chippers with alternated chipper blades and a conventional fan attached to it. It will economomize and accelerate the way of cutting tree parts in different in angles.

### FEDERALLY SPONSORED RESEARCH

Not Applicable

### SEQUENCE LISTING OR PROGRAM

Not Applicable

### BACKGROUND

1. Field of Invention

This invention relates to chippers, specifically to improve the way of cutting tree parts in different angles.

2. Description of Prior Art

Dealers and tree equipment manufacture companies commonly supply consumers with chippers to cut tree parts. Such chippers are also used by suppliers to provide a recyclable process for tree parts both usable and unusable.

Originally these chippers have cut by the users small tree parts. However, consumers objected since these were of a rather permanent nature: the small tree parts could be cut only by cutting them or using only small tree parts, and cutting them only one by one, thereby taking more time from the consumers to process any tree parts and rendering them impossible to cut any tree part.

Thereafter, inventors created several types of chippers to cut tree parts in such way as to cut almost any tree parts.

Thus if more than one tree part was feed into the chipper it will reject or shut down automatically consequently taking more time to process. Also creating permanent damages to the chipper due to over load of wood.

### OBJECTS AND ADVANTAGES

Accordingly, besides the objects and advantages of the regular cutting heads for the chippers described in my above patent, several objects and advantages of the present invention are:

(a) to provide a process of cutting tree parts which can be cut in different angles due to the shape of the V-Drum Cutting Head with alternated chipper blades

(b) to provide a process of cutting tree parts in a safer way were the chipper will not be rejecting any tree parts.

(c) to provide a process of cutting tree parts with the variety of size without requiring the user to cut tree parts into small pieces.

(d) to provide a process of cutting tree parts faster almost with out stopping

(e) to provide a process of cutting tree parts with a less consumption of fuel and time.

Further objects and advantages are to provide a better process of cutting tree parts, which can be used easily and conveniently to cut any tree parts, without damage the chipper heads, which is simple to use and inexpensive to manufacture. Still further objects and advantages will become apparent form a consideration of the ensuing description and drawings.

### SUMMARY

In accordance with the present invention cutting heads for chippers comprises a V-Drum Cutting Heads also alternated chipper blades with attached fan located behind of the cutting head which will be helping in the process of moving out tree parts already cut.

### DRAWING

FIG. 1A shows aspects of the V-Drum Cutting Head the fan attached to de chipper that helps with the process of tree parts and a detail parts for this new invention.

### REFERENCE NUMERALS IN DRAWINGS

1 Infeed shut

2 Bolts

3 Fan

4 Cutting head

5 Chipper blades

6 Access door

7 Discharge shut

### DETAILED DESCRIPTION

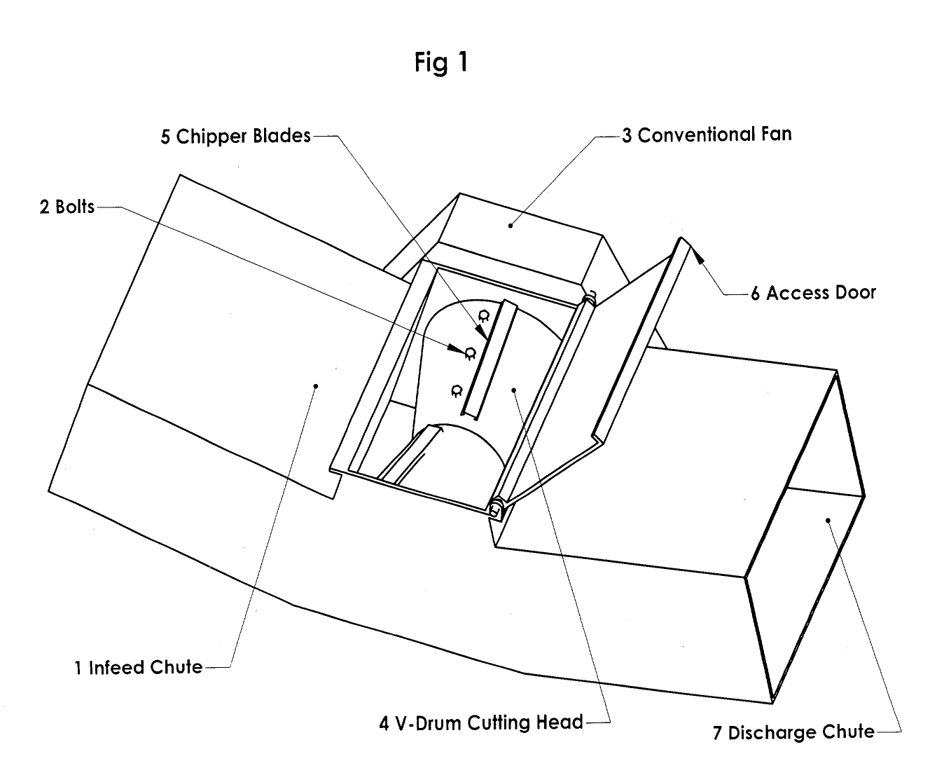

The present invention is illustrated in FIG. 1A (top view) the V-Drum Cutting Head 4 a metal head with a trapezoid shape attached together in opposite directions with each other with alternated chipper blades 5 tighten with holds 2 to latch every single blade. Trough the infeed shut 1 the tree parts will enter to be ground. A conventional fan 3 placed on the upper center of the cutting head will rotate to help the movement through the discharge shut 7 the access door 6 is to keep maintenance for the V-Drum Cutting Head.

Advantages

From the description above, a number of advantages of my V-Drum Cutting Head and Fan attachment become evident:

(a) This new V-Drum Cutting Head with alternated chipper blades will cut tree parts in different angels.

(b) Time and fuel Consumption will be less which create savings to the owner(s) and operator(s) of these new chippers.

(c) The fan attached to the chippers will help with the speeding process

These new additions to the chippers will speed the process of cutting tree parts.

Operation

The manner of using these new chippers before the user turn on the machine, make sure the alternated chipper blades 5 are tighten with the bolts 2 to the V-Drum Cutting Head 4, then close and lock the access door 6, turn it on and place tree parts in a horizontal way on the infeed shut 1. When the cutting head rotate will cut any tree part in different angles this will accelerate the cutting process and the attached conventional fan 3 will help with the circulation through the discharge shut 7

Conclusion, Ramifications, and Scope

Accordingly, the reader will see that the V-Drum Cutting Head chipper with the fan attached to it can be use to cut any tree part easily and conveniently, can cut any tree parts just as easily and with out damage to the cutting heads. In addition, when tree parts are cut the alternated chipper blades will help to reduce damages to the V-Drum Cutting Head, this cutting process will cut any tree parts in different angles with out impairing the ability of the cutting process to reuse tree parts. Furthermore, the cutting process has the additional advantages in that

it provides a less consumption of fuel and time.

it allows tree parts to be cut in different angles with out the need to previously cut the wood in to small pieces to run it into the V-Drum Cutting Head chippers.

it permits to recycle any tree parts in a variety of sizes with out the manufacture to use a separate machine.

it provides a safer way to cut tree parts.

Although the description above contains many specificities, these should not be constructed as limiting the scope of the invention but as merely provinding illustations of some of the presently preferred embodiments of this invention.

For example, the cutting process will allow the user to cut tree parts in different angles due to the alternated chipper blades different cuts will be done

Thus the scope of the invention should be determined by the appended claims and their legal equivalents, rather than by the examples given.

I claim:

1. The V-Drum Cutting Heads comprising a trapezoid shape attached together with alternated chipper blades tighten to the cutting head and an attached fan

2. The V-Drum cutting head of claim 1 is composed of 2 metal parts with trapezoid shapes bond together.

3. The V-Drum cutting head of claim 1 with alternated chipper blades along of the cutting head

4. The V-Drum cutting head comprising a conventional fan that will on the process of cutting tree parts making it more efficient and faster
The chippers with the V-Drum Cutting head have a conventional fan attached on the upper center part of the cutting head that will help the circulation for the wood chips through the discharge shut.
